(19) United States
(12) Patent Application Publication
(10) Pub. No.: US 2018/0247163 A1
(43) Pub. Date: Aug. 30, 2018

(54) COMPUTER SYSTEM AND DATA CLASSIFICATION METHOD

(71) Applicant: Hitachi, Ltd., Tokyo (JP)

(72) Inventors: Takuya ODA, Tokyo (JP); Qi XIU, Tokyo (JP)

(21) Appl. No.: 15/753,979

(22) PCT Filed: Mar. 23, 2016
(86) PCT No.: PCT/JP2016/059222

§ 371 Date: Feb. 21, 2018

(51) Int. Cl. G06K 9/62; G06F 17/30; G06N 7/00

(52) U.S. Cl. CPC G06K 9/6277; G06K 9/6215; G06K 9/6256; G06N 7/005; G06F 17/30707; G06F 17/30613; G06K 9/6262

(57) ABSTRACT

At least one of a plurality of computers includes a learning module that generates, by using teacher data, distribution information for calculating an index used in classification of a data type of target data and outputs the distribution information to a computer including a classification module, which uses the distribution information to classify the data type of the target data. The learning module calculates, based on data lengths of the teacher data, first probabilities indicating a probability at which a character appears at an appearance position and second probability indicating a probability at which dummy data appears at an appearance position; and sets first entries each including the data type, a character included in the teacher data, an appearance position of the character, and the first probability, and second entries each including the data type, a dummy data, an appearance position of the dummy, and the second probability.

### BACKGROUND OF THE INVENTION

This invention relates to a method of classifying character strings and other types of data.

In manufacturing, financial, and other industries, there is a demand for a system that uses data obtained from an operational system or other sources to improve productivity and provide assistance in making decisions.

Data obtained from an operational system includes a plurality of values. The obtained data is stored in a database as data made up of a plurality of cells. Cells in the same data column accordingly store various types of values.

There are cases in which the same data undergoes a change in cell configuration from initial settings due to the diversification of manufacturing equipment and sensors, system maintenance, a design error in the database, system integration, or the like.

To use the obtained data, it is required to determine, for each cell, the type and other attributes of data stored in the cell. A technology known to be applicable for this determination is described in U.S. Pat. No. 8,732,183 B2. The technology described in U.S. Pat. No. 8,732,183 B2 automatically classifies data based on the similarity of characters in the data.

### SUMMARY OF THE INVENTION

The related art of U.S. Pat. No. 8,732,183 B2 has a problem in that character strings of, for example, product identifiers, equipment identifiers, or other identifiers cannot be classified correctly because identifiers and the like use character strings in which the arrangement of characters is similar to one another and which have character sets similar to one another.

In order to classify identifiers and the like correctly, the length of a character string is required to be taken into account as well. More specifically, the length of a character string to be classified is required to be changed so as to suit the type of a character string to be compared, before the similarity is calculated.

It is an object of this invention to provide a system and a method with which character strings of identifiers and the like are classified correctly.

The present invention can be appreciated by the description which follows in conjunction with the following figures, wherein: a computer system comprising a plurality of computers, each of the plurality of computers having a processor, a main storage device coupled to the processor, and an interface coupled to the processor. At least one of the plurality of computers includes a learning module, the learning module being configured to use a plurality of pieces of teacher data belonging to a plurality of data types, respectively, to generate distribution information for calculating an index that is used in classification of a data type of target data, and output the distribution information to a computer that includes a classification module, which is configured to use the distribution information to classify the data type of the target data. Each of the plurality of pieces of teacher data is a character string, which includes at least one character. The learning module is configured to: execute learning processing, which uses the plurality of pieces of teacher data belonging to the plurality of data types, respectively, to thereby add, to the distribution information, a plurality of first entries each including one of the plurality of data types, a character included in one of the plurality of pieces of teacher data belonging to the one of the plurality of data types, and an appearance position at which the character appears in a character string; add, to the distribution information, a given number of second entries each including one of the plurality of data types, dummy data added in order to adjust a data length of the target data, and an appearance position at which the dummy data appears in a character string; calculate first probabilities based on data lengths of the plurality of pieces of teacher data belonging to the plurality of data types that are included in the plurality of first entries, the first probabilities each indicating a probability at which the character included in one of the plurality of first entries appears at an appearance position included in the one of the plurality of first entries; calculate second probabilities based on data lengths of the plurality of pieces of teacher data belonging to the plurality of data types that are included in the given number of second entries, the second probabilities each indicating a probability at which the dummy data included in one of the given number of second entries appears at an appearance position included in the one of the given number of second entries; and set the first probabilities and the second probabilities to the plurality of first entries and the given number of second entries, respectively.

According to this invention, the computer including the classification module can classify character strings of identifiers and the like correctly by using distribution information to which entries for a given number of pieces of dummy data are added for each data type. Problems, configurations, and effects other than described above will become apparent from a description of an embodiment below.

### BRIEF DESCRIPTION OF THE DRAWINGS

The present invention can be appreciated by the description which follows in conjunction with the following figures, wherein:

FIG. 1 is a diagram for illustrating an example of a configuration of a computer system according to a first embodiment of this invention,

FIG. 2 is a table for illustrating an example of teacher data management information in the first embodiment,

FIG. 3 is a table for illustrating an example of correction level management information in the first embodiment,

FIG. 4 is a table for illustrating an example of character appearance distribution information in the first embodiment,

FIG. 5 is a table for illustrating an example of classification target data management information in the first embodiment,

FIG. 6 is a table for illustrating an example of similarity calculation result information in the first embodiment,

FIG. 7 is a table for illustrating an example of classification result information in the first embodiment,

FIG. 8 is a diagram for illustrating an example of a correction level setting screen in the first embodiment,

FIG. 9 is a diagram for illustrating an example of a classification result check/update screen in the first embodiment,

FIG. 10 is a flow chart for illustrating an example of learning processing executed by a learning server in the first embodiment,

FIG. 11 is a flow chart for illustrating an example of appearance ratio calculation processing executed by the learning server in the first embodiment,

FIG. 12 is a flow chart for outlining processing executed by a classification server in the first embodiment,

FIG. 13 is a flow chart for illustrating an example of similarity calculation processing executed by the classification server in the first embodiment, and

FIG. 14 is a flow chart for illustrating an example of classification processing executed by the classification server in the first embodiment.

### DETAILED DESCRIPTION OF THE PREFERRED EMBODIMENTS

A description outlining this invention is given. In the following description, data (a character string) to be classified is also referred to as “target data”.

The data lengths of teacher data and target data, namely, the lengths of character strings, are required to be taken into account in order to correctly classify target data, which is an identifier or the like. More specifically, the data length of target data (the length of a character string) is required to be changed so as to suit the type of a character string to be compared, before the similarity is calculated. The method of adjusting the character string length is also required to be changed so as to suit the data type because the data length of teacher data varies from data type to data type. Another factor to be considered is fluctuations in the data length of teacher data because the data length fluctuates even among pieces of teacher data that belong to the same data type.

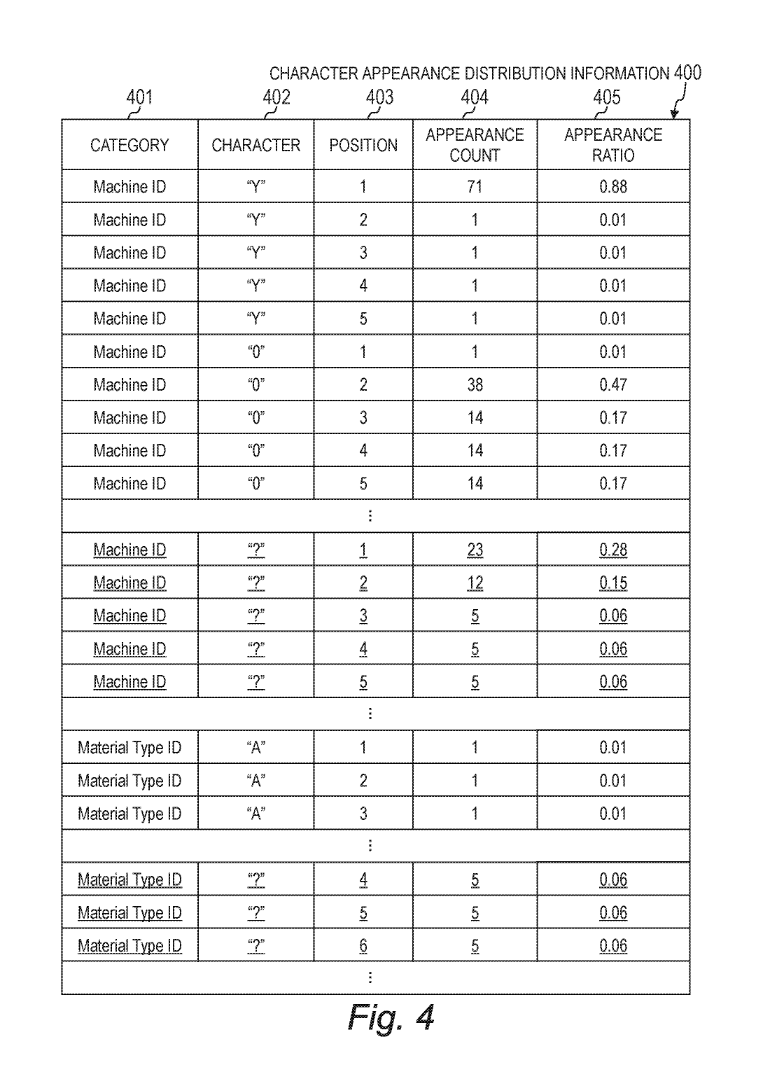

Characteristic processing is therefore executed for a learning phase and a classification phase each in a system to which this invention is applied. The processing executed in the learning phase generates character appearance distribution information 400 shown in FIG. 4, which is used to classify target data, with the use of teacher data of a plurality of data types. The processing executed in the classification phase classifies target data based on the character appearance distribution information 400.

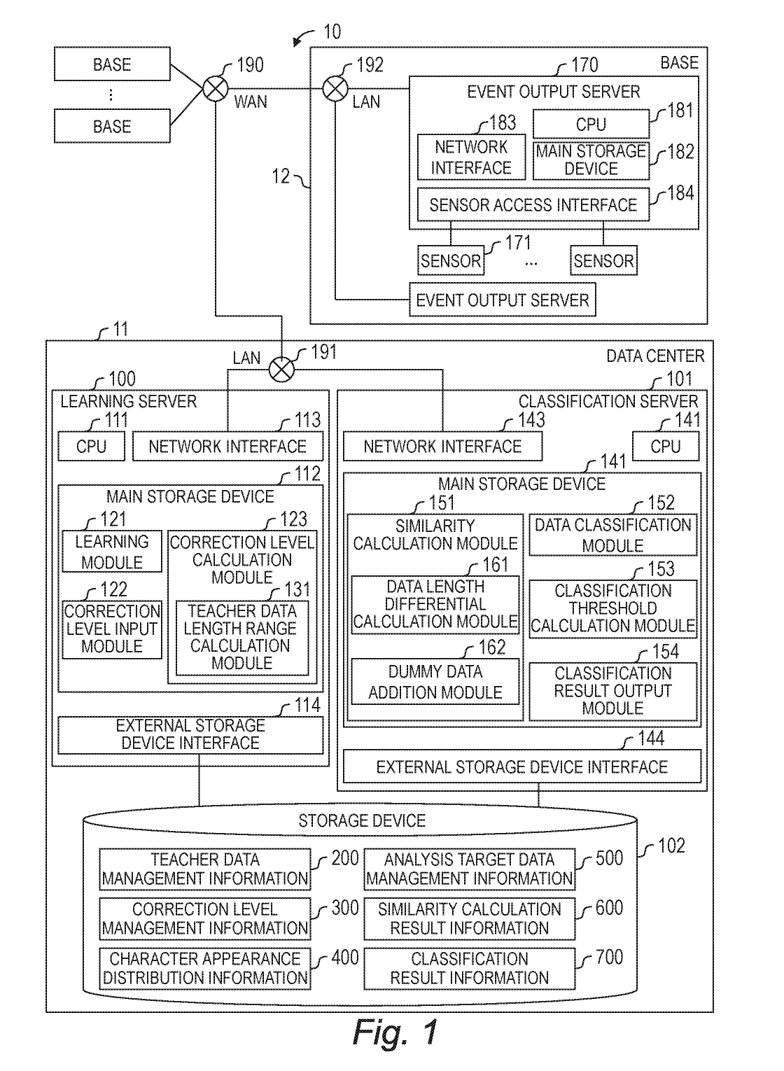

In the learning phase of this invention, a learning server 100 illustrated in FIG. 1 generates the character appearance distribution information 400 based on the data type of teacher data, a position at which a character appears in the teacher data, and the character string length. Entries for dummy data, which is used to adjust the data length of target data, are registered for each data type in the character appearance distribution information 400 in an embodiment of this invention.

In the classification phase of this invention, a classification server 101 illustrated in FIG. 1 adds a given number of pieces of dummy data to target data to suit the data type of teacher data before the target data is compared to the teacher data. The classification server 101 calculates similarity between the target data and the teacher data based on the character appearance distribution information 400 and on the result of comparison between the target data adjusted in data length and the teacher data. The classification server 101 classifies the data type of the target data based on the calculated similarity.

In this invention, as described above, the learning processing and the classification processing in which the data length of teacher data of each data type is taken into account are executed. An embodiment of this invention is described below with reference to the accompanying drawings.

### First Embodiment

FIG. 1 is a diagram for illustrating an example of a configuration of a computer system 10 according to a first embodiment of this invention.

The computer system 10 includes a data center 11 and a plurality of bases 12. The data center 11 and the plurality of bases 12 are coupled to each other via a wide area network (WAN) 190.

The data center 11 is described first. The data center 11 is a system for providing a service for classifying the data type of data (target data) of cells, which are included in a data string (event information) transmitted from each of the bases 12. The data center 11 includes the learning server 100, the classification server 101, and a storage device 102. The learning server 100 and the classification server 101 are coupled to each other via a local area network (LAN) 191.

The learning server 100 generates various types of information used for target data classification processing. The hardware configuration of the learning server 100 includes a CPU 111, a main storage device 112, a network interface 113, and an external storage device interface 114.

The CPU 111 is an arithmetic device configured to execute a program stored in the main storage device 112. The CPU 111 executes the program, to thereby implement functions of the learning server 100. When a function module is the subject of a sentence describing processing below, it means that the CPU 111 is executing a program that implements the function module.

The main storage device 112 is a storage medium in which a program executed by the CPU 111 and information required to execute the program are stored. The storage area of the main storage device 112 includes a work area used by a program.

The network interface 113 is an interface with which the learning server 100 is coupled to other apparatus via a network. The external storage device interface 114 is an interface with which the learning server 100 is coupled to an external storage device.

A program stored in the main storage device 112 is described. The main storage device 112 stores a program that implements a learning module 121, a correction level input module 122, and a correction level calculation module 123.

The learning module 121 cooperates with the correction level input module 122 and the correction level calculation module 123 to execute learning processing, which uses teacher data. The correction level input module 122 inputs and outputs data about the correction level. The correction level calculation module 123 calculates the correction level. The correction level is a value related to dummy data, which is added in order to adjust the data length of target data, for example, a value for correcting the appearance ratio and the number of pieces of dummy data to be added. The correction level calculation module 123 includes a teacher data length range calculation module 131. The teacher data length range calculation module 131 calculates a range indicating fluctuations in the data length of pieces of teacher data that have the same data type.

The functions of the learning module 121, the correction level input module 122, and the correction level calculation module 123 may be integrated into one function module, or may be divided among a plurality of function modules. For example, the learning module 121 may have the functions of the correction level input module 122 and the correction level calculation module 123.

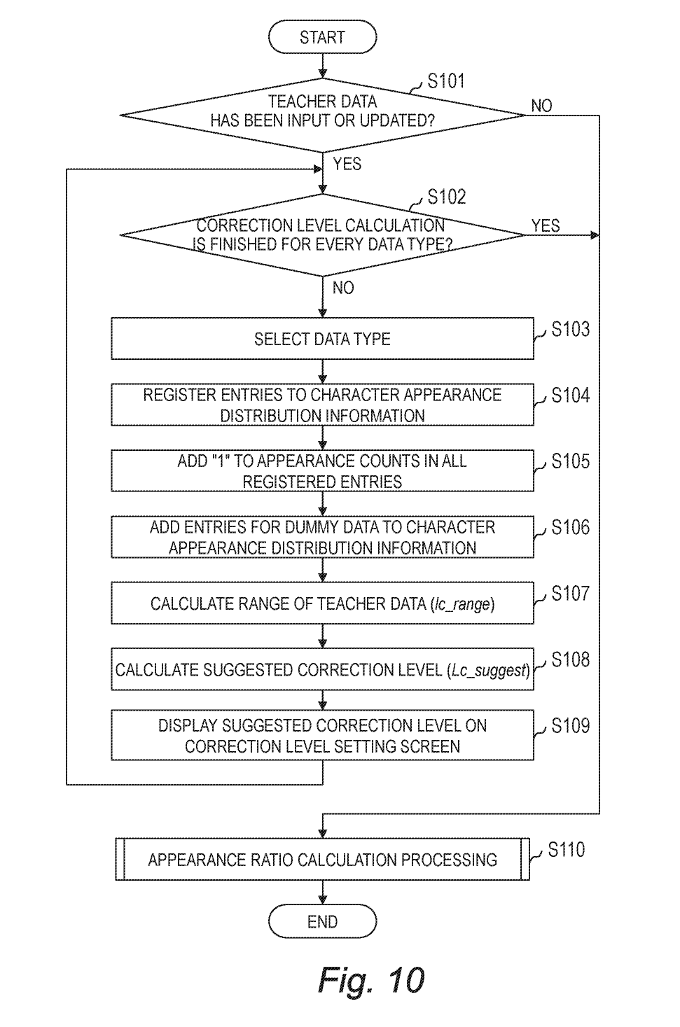

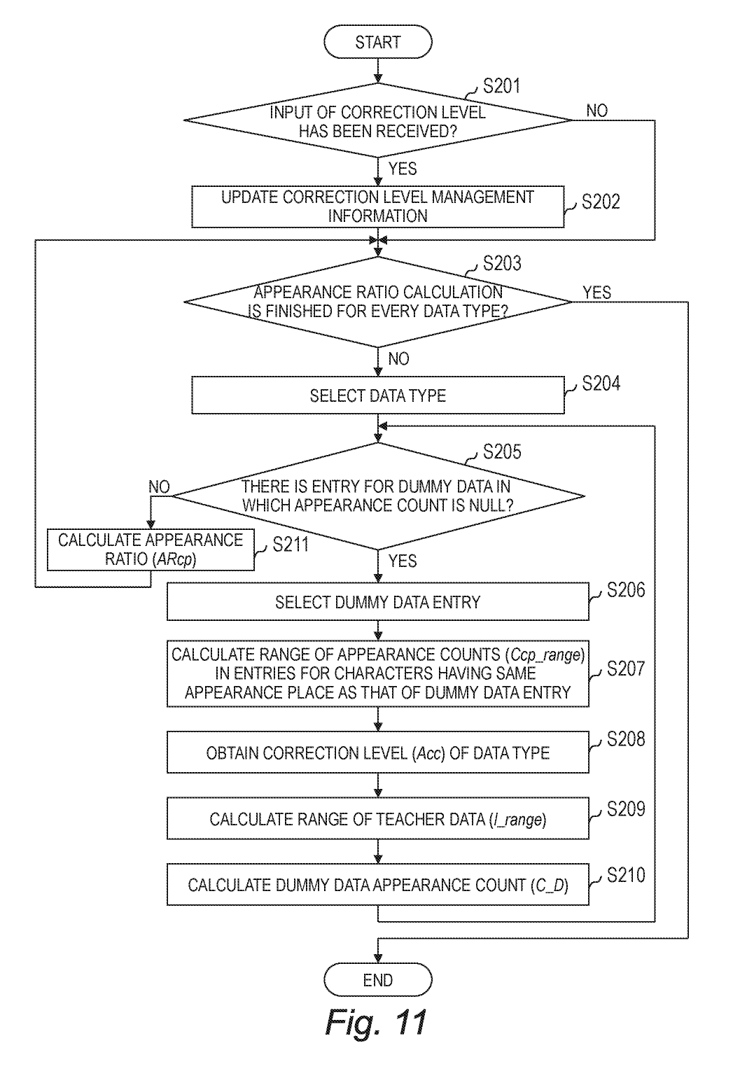

Details of processing executed by the learning module 121, the correction level input module 122, and the correction level calculation module 123 are described with reference to FIG. 10 and FIG. 11.

The classification server 101 executes the target data classification processing. The hardware configuration of the classification server 101 includes a CPU 141, a main storage device 142, a network interface 143, and an external storage device interface 144.

The CPU 141, the main storage device 142, the network interface 143, and the external storage device interface 144 are the same as the CPU 111, the main storage device 112, the network interface 113, and the external storage device interface 114, respectively, and descriptions thereof are accordingly omitted.

The main storage device 142 stores a program that implements a similarity calculation module 151, a data classification module 152, a classification threshold calculation module 153, and a classification result output module 154.

The similarity calculation module 151 calculates the similarity used to determine the data type of target data. The data classification module 152 classifies target data based on the similarity and a classification threshold. The classification threshold calculation module 153 calculates a classification threshold used in target data classification processing. The classification result output module 154 outputs the result of classifying target data.

The functions of the similarity calculation module 151, the data classification module 152, the classification threshold calculation module 153, and the classification result output module 154 may be integrated into one function module, or may be divided among a plurality of function modules. For example, the data classification module 152 may have the functions of the similarity calculation module 151, the classification threshold calculation module 153, and the classification result output module 154.

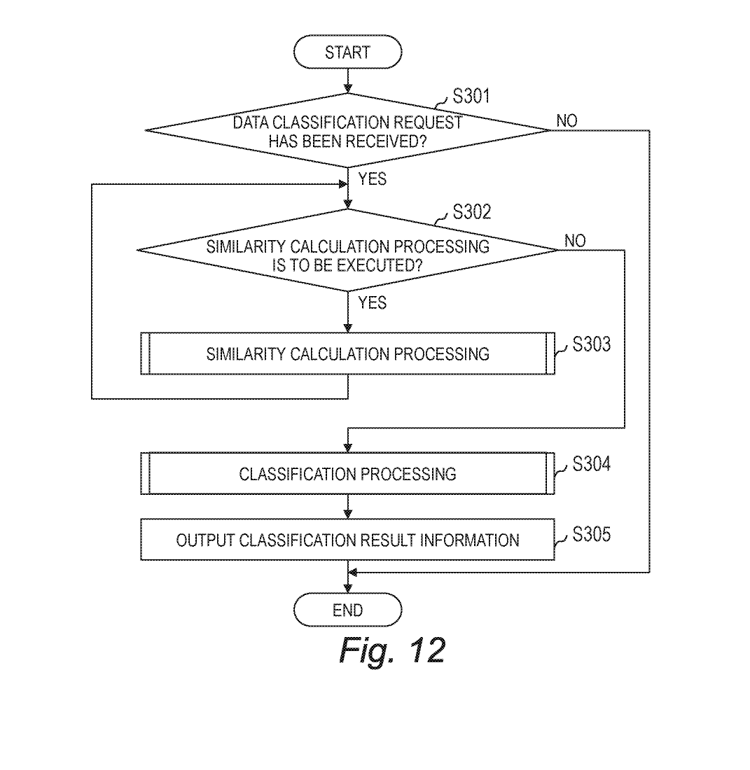

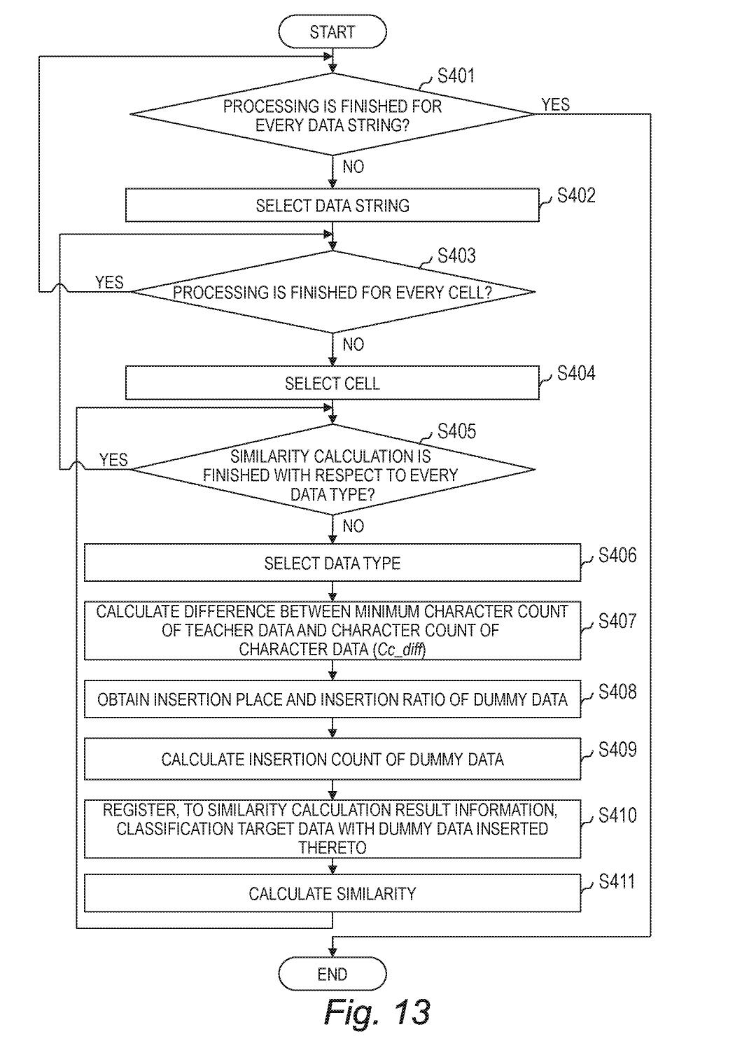

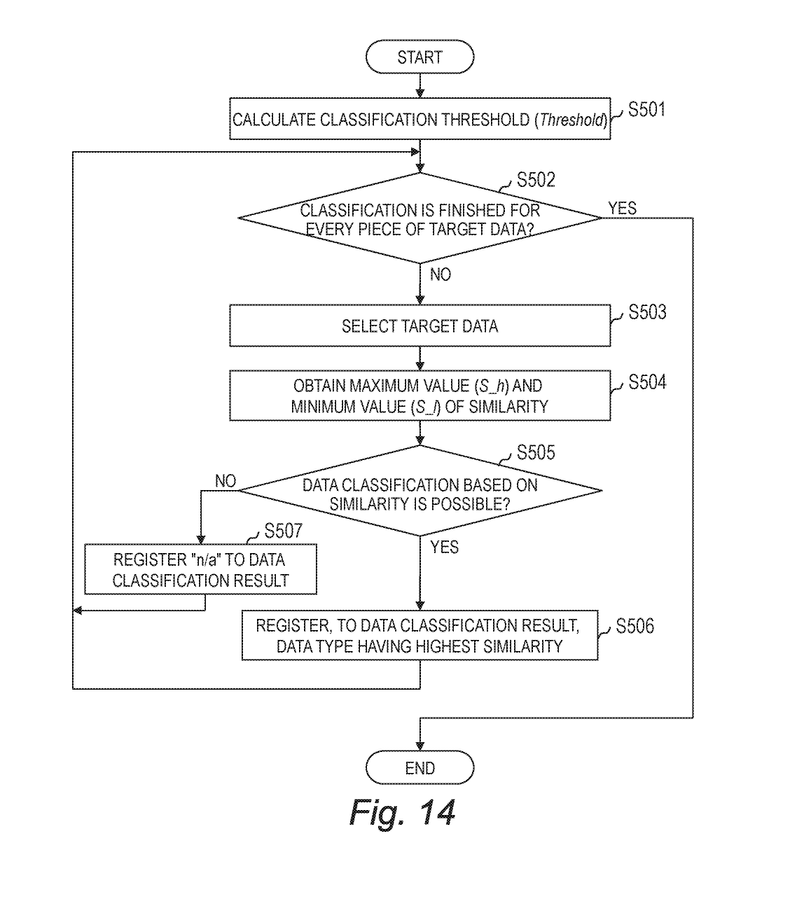

Details of processing executed by the similarity calculation module 151, the data classification module 152, the classification threshold calculation module 153, and the classification result output module 154 are described with reference to FIG. 12, FIG. 13, and FIG. 14.

The storage device 102 stores various types of data. The storage device 102 can be, for example, a storage system in which a controller and a plurality of storage media are included. The storage device 102 may be a general computer in which a storage medium is included, or a storage medium itself. The storage medium can be a hard disk drive (HDD), a solid state drive (SSD), or the like.

The storage device 102 in the first embodiment stores teacher data management information 200, correction level management information 300, the character appearance distribution information 400, classification target data management information 500, similarity calculation result information 600, and classification result information 700.

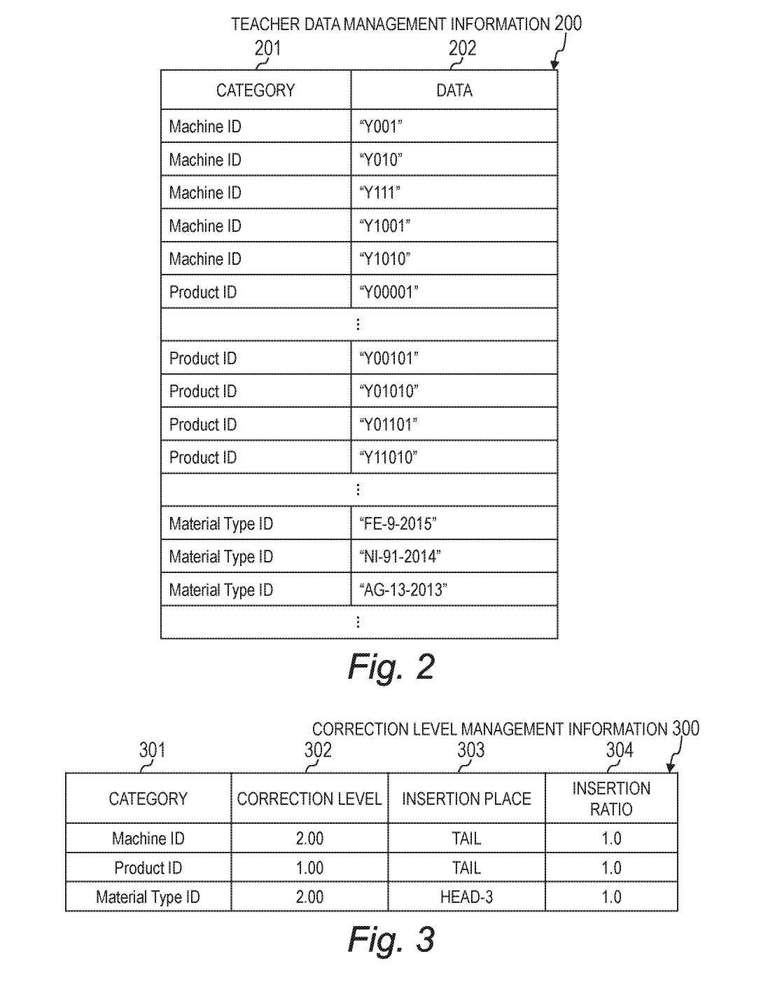

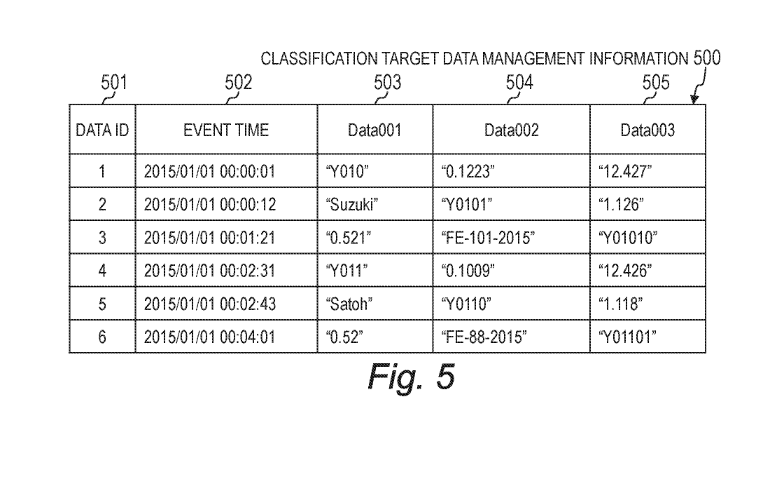

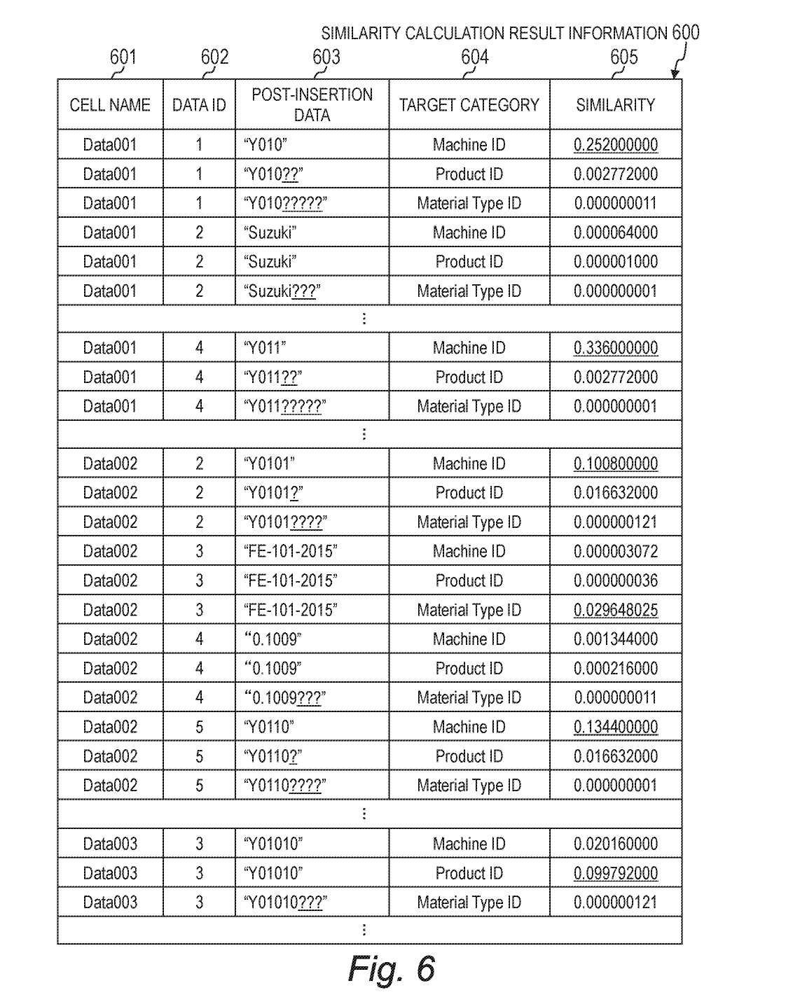

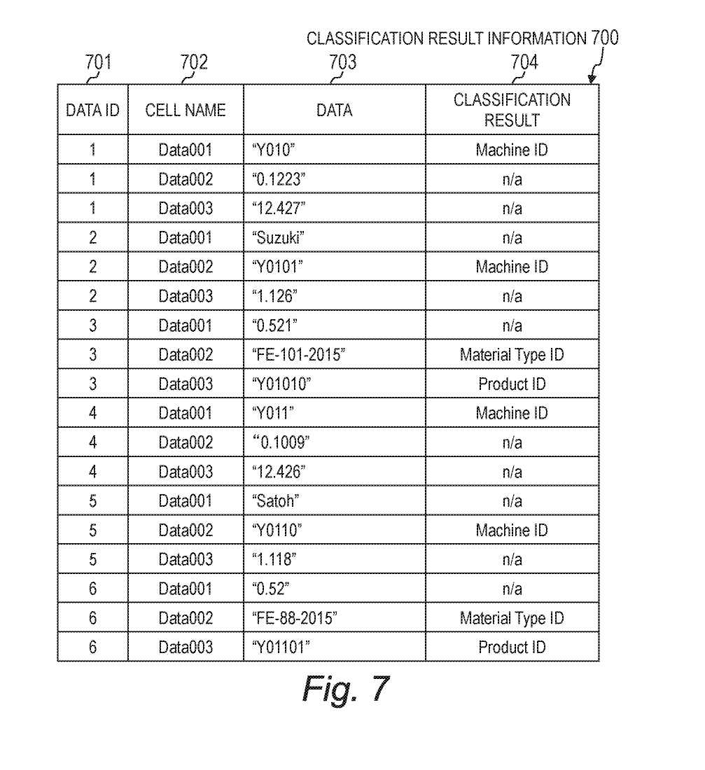

Details of the teacher data management information 200 are described with reference to FIG. 2. Details of the correction level management information 300 are described with reference to FIG. 3. Details of the character appearance distribution information 400 are described with reference to FIG. 4. Details of the classification target data management information 500 are described with reference to FIG. 5. Details of the similarity calculation result information 600 are described with reference to FIG. 6. Details of the classification result information 700 are described with reference to FIG. 7.

The bases 12 are described next. In each of the bases 12, a system with which an arbitrary business operation is accomplished is built. The system includes an event output server 170. The event output server 170 is coupled to a plurality of sensors 171. The first embodiment is not limited to any particular method of coupling between the event output server 170 and the sensors 171.

The sensors 171 output event data including information related to the business operation.

The event output server 170 collects event data from the sensors 171, and transmits the event data to the data center 11. The transmitted event data is registered to the classification target data management information 500 by one of the learning server 100 and the classification server 101.

The hardware configuration of the event output server 170 includes a CPU 181, a main storage device 182, a network interface 183, and a sensor access interface 184.

The CPU 181, the main storage device 182, and the network interface 183 are the same as the CPU 111, the main storage device 112, and the network interface 113, respectively, and descriptions thereof are accordingly omitted. The sensor access interface 184 is an interface with which the event output server 170 is coupled to the sensors 171.

The learning server 100 and the classification server 101 may be implemented with the use of a virtual computer generated by a virtualization technology.

FIG. 2 is a table for illustrating an example of the teacher data management information 200 in the first embodiment.

The teacher data management information 200 is information for managing teacher data. The teacher data management information 200 includes a plurality of entries, each of which is made up of a category 201 and data 202. One entry corresponds to one piece of teacher data. Each entry may include other cells.

The category 201 indicates the data type. The data 202 indicates a specific value of the piece of teacher data. Teacher data in the first embodiment is a string of one or more characters. A character string of the data 202 enclosed by double quotation marks is the value of the piece of teacher data.

The related art requires a complete set of pieces of teacher data in order to enhance the precision of classification. In contrast, the number of pieces of teacher data in the first embodiment is only required to be large enough to figure out, for each data type, a character pattern and a character string length pattern that are unique to the data type.

FIG. 3 is a table for illustrating an example of the correction level management information 300 in the first embodiment.

The correction level management information 300 is information for managing the correction level of each data type. The correction level management information 300 includes a plurality of entries, each of which is made up of a category 301, a correction level 302, an insertion position 303, and an insertion ratio 304. One entry is included for one data type in the first embodiment.

The category 301 is the same as the category 201. The correction level 302 indicates a specific value of the correction level. The insertion position 303 is information indicating a position in target data at which dummy data is inserted. The insertion ratio 304 indicates the proportion of dummy data inserted at the insertion position 303. A real number of from “1.0” to “0” is stored as the insertion ratio 304 in the first embodiment.

A description is given by taking as an example a case in which the number of pieces of dummy data inserted is four.

In a case where an entry in which the category 301 is “Machine ID”, the insertion position 303 is “TAIL”, and the insertion ratio 304 is “1.0” is registered in the correction level management information 300, four pieces of dummy data are inserted at the tail end of target data.

In a case where an entry in which the category 301 is “Machine ID”, the insertion position 303 is “HEAD-3”, and the insertion ratio 304 is “0.5” and an entry in which the category 301 is “Machine ID”, the insertion position 303 is “TAIL”, and the insertion ratio 304 is “0.5” are registered in the correction level management information 300, two pieces of dummy data are inserted at the third character from the head of target data, and two pieces of dummy data are inserted at the tail end of target data.

FIG. 4 is a table for illustrating an example of the character appearance distribution information 400 in the first embodiment.

The character appearance distribution information 400 is information used to calculate the similarity between teacher data and target data. The character appearance distribution information 400 is generated by learning processing, which uses teacher data.

The character appearance distribution information 400 includes a plurality of entries, each of which is made up of a category 401, a character 402, a position 403, an appearance count 404, and an appearance ratio 405.

The category 401 is the same as the category 201. The character 402 indicates a specific character. The position 403 indicates a position at which the character indicated by the character 402 appears in a character string. The appearance count 404 indicates the number of times (an accumulated value) the character indicated by the character 402 appears at the appearance position indicated by the position 403. The appearance ratio 405 indicates a probability at which the character 402 appears at the position 403 in a character string belonging to the category 401.

The character appearance distribution information 400 in the first embodiment has a feature in including entries for dummy data in addition to entries for characters as shown in FIG. 4. One question mark corresponds to one piece of dummy data.

FIG. 5 is a table for illustrating an example of the classification target data management information 500 in the first embodiment.

The classification target data management information 500 is information for managing a data string (event data) made up of a plurality of cells in which target data is stored. The classification target data management information 500 includes a plurality of entries, each of which is made up of a data ID 501, an event time 502, Data001 (503), Data002 (504), and Data003 (505). One entry corresponds to one data string.

The data ID 501 indicates identification information for uniquely identifying a data string (event data). The event time 502 indicates a time at which the data string is generated or obtained.

The Data001 (503), the Data002 (504), and the Data003 (505) indicate values included in the event data.

In the first embodiment, values stored as the Data001 (503), the Data002 (504), and the Data003 (505) are target data. Character strings of the Data001 (503), the Data002 (504), and the Data003 (505) enclosed by double quotation marks are target data to be classified.

FIG. 6 is a table for illustrating an example of the similarity calculation result information 600 in the first embodiment.

The similarity calculation result information 600 is information for managing the result of calculating the similarity between target data and teacher data. The similarity calculation result information 600 includes a plurality of entries, each of which is made up of a cell name 601, a data ID 602, post-insertion data 603, a target category 604, and a similarity 605.

The cell name 601 indicates the name of a cell of a data string. The data ID 602 indicates identification information of the data string in which target data is included. The post-insertion data 603 indicates target data to which dummy data has been inserted.

The target category 604 indicates a data type to which teacher data to be compared with the target data belongs. The similarity 605 indicates the similarity between the target data to which dummy data has been inserted and the teacher data belonging to the target category 604.

FIG. 7 is a table for illustrating an example of the classification result information 700 in the first embodiment.

The classification result information 700 is information for managing the result of classifying target data. The classification result information 700 includes a plurality of entries, each of which is made up of a data ID 701, a cell name 702, data 703, and a classification result 704. One entry corresponds to the result of classifying one piece of target data included in an arbitrary data string.

The data ID 701 is the same as the data ID 501. The cell name 702 is the same as the cell name 601. The data 703 indicates target data that is stored in the cell indicated by the data ID 701 and the cell name 702. The classification result 704 indicates the result of classifying the target data indicated by the data 703.

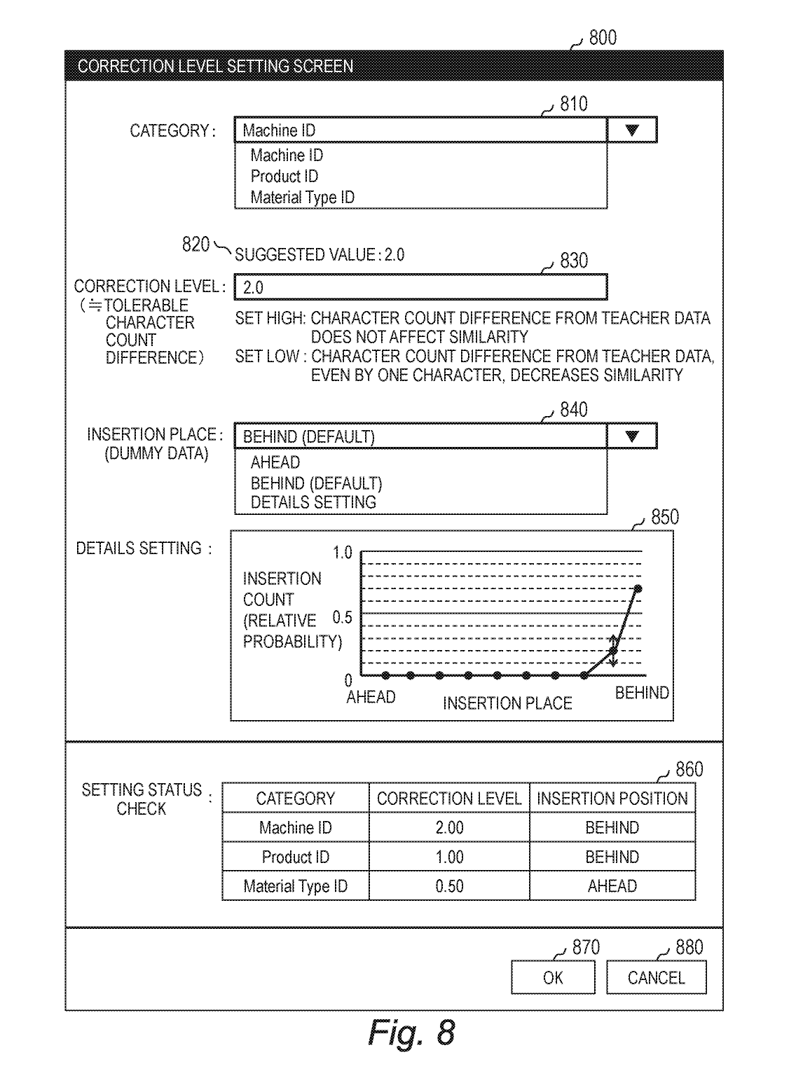

FIG. 8 is a diagram for illustrating an example of a correction level setting screen 800 in the first embodiment.

The correction level setting screen 800 includes a category input field 810, a suggested correction level display field 820, a correction level input field 830, an insertion place input field 840, a details setting field 850, a setting status check field 860, an “OK” button 870, and a “cancel” button 880.

The category input field 810 is a field for inputting a data type for which the correction level is set. In the first embodiment, a user selects a data type displayed in a pull-down menu format.

The suggested correction level display field 820 is a field in which a default value of the correction level is displayed. The correction level input field 830 is a field for inputting a value of the correction level. In the first embodiment, descriptive text indicating a relationship between the magnitude of a value of the correction level and a similarity is displayed below the correction level input field 830.

The insertion place input field 840 is a field for inputting a position in target data at which dummy data is inserted. In the first embodiment, the user selects an insertion position displayed in a pull-down menu format. The details setting field 850 is a field for setting details of the dummy data to be inserted to the target data. Settings can be input to the details setting field 850 only after “details setting” is input in the insertion place input field 840. A graph in which an insertion place and an insertion count are input is displayed in the details setting field 850 in the first embodiment.

The setting status check field 860 is a field for displaying settings that are set by inputting values with the use of the category input field 810, the suggested correction level display field 820, the correction level input field 830, the insertion place input field 840, and the details setting field 850.

The “OK” button 870 is an operation button that is operated to register values input in the correction level setting screen 800. The “cancel” button 880 is an operation button that is operated to cancel the registration of values set in the correction level setting screen 800.

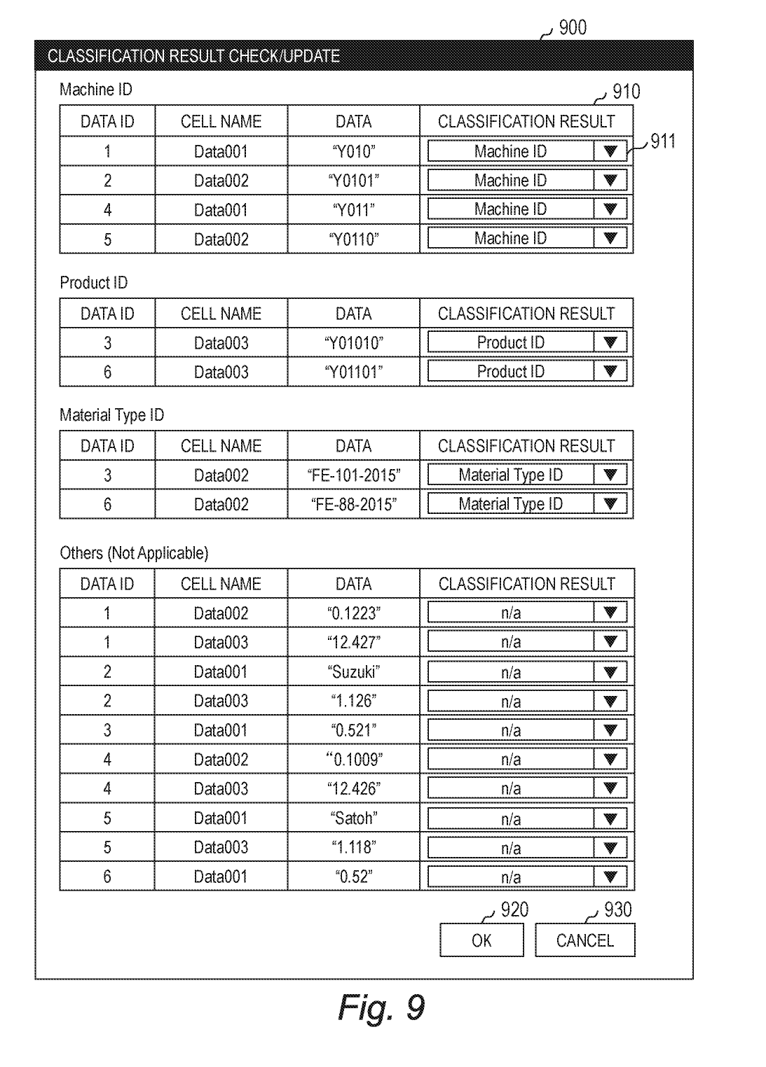

FIG. 9 is a diagram for illustrating an example of a classification result check/update screen 900 in the first embodiment.

The classification result check/update screen 900 includes a classification result display field 910 for each data type, an “OK” button 920, and a “cancel” button 930.

The classification result display field 910 is generated by extracting, for each data type, classification results from the classification result information 700. A cell 911 of a classification result in the classification result display field 910 can be changed by the user.

The “OK” button 920 is an operation button operated to enter classification results. The “cancel” button 930 is an operation button operated to cancel the entering of classification results.

Details of processing executed by the learning server 100 and the classification server are described next. First, details of processing executed by the learning server 100 are described with reference to FIG. 10 and FIG. 11.

The classification result information 700 itself may be displayed on the classification result check/update screen 900.

FIG. 10 is a flow chart for illustrating an example of the learning processing executed by the learning server 100 in the first embodiment.

The learning server 100 determines whether teacher data has been input or updated (Step S101). For instance, the learning server 100 determines that teacher data has been input in a case where the teacher data management information 200 has been registered. The learning server 100 determines that teacher data has been updated in a case where an update has been made to the teacher data management information 200.

In a case where it is determined that teacher data has not been input or updated, the learning server 100 proceeds to Step S110.

In a case where it is determined that teacher data has been input or updated, the learning server 100 determines whether correction level calculation is finished for every data type (Step S102).

Specifically, the learning module 121 refers to the category 301 of the correction level management information 300 to determine whether an entry is registered for every data type. In a case where not every data type has an entry registered, the learning server 100 determines that correction level calculation is not finished for every data type.

In a case where it is determined that correction level calculation is finished for every data type, the learning server 100 proceeds to Step S110. In a case where it is determined that correction level calculation is not finished for every data type, the learning server 100 selects one target data type from among data types for which correction level calculation is not finished (Step S103).

The learning server 100 next registers an entry to the character appearance distribution information 400, based on teacher data that belongs to the selected data type (Step S104). Specifically, the following processing is executed.

The learning module 121 measures, for each appearance position, the appearance count of a character in learning data that belongs to the selected data type. The learning module 121 registers the result of the measurement to the character appearance distribution information 400. For example, the learning module 121 learns teacher data with the use of a Naïve Bayes classifier or other learning machines, to thereby measure the appearance count of a character for each appearance position.

As many entries as the number of combinations of a character type and a character's appearance position are registered in the character appearance distribution information 400. A selected data type is set as the category 401 in each entry. A given character and the given character's appearance point are set as the character 402 and the position 403, respectively, in each entry. A measurement result is stored as the appearance count 404 in each entry.

At this point, only an entry related to a character that is included in teacher data is registered to the character appearance distribution information 400. The appearance ratio 405 is blank in each entry registered to the character appearance distribution information 400. This concludes the description on the processing of Step S104.

The learning server 100 next adds “1” to the appearance count 404 of every entry registered in Step S104 (Step S105). This is for avoiding the sparseness problem. The learning server 100 may add “1” to every entry in the character appearance distribution information 400 in a case where the answer to the determination of Step S102 is “YES”.

The learning server 100 next adds entries for dummy data of the selected data type to the character appearance distribution information 400 (Step S106). Specifically, the following processing is executed.

The learning module 121 refers to entries in which the category 401 matches the selected data type to identify the maximum value of the position 403. The learning module 121 adds as many entries as the maximum value of the position 403 to the character appearance distribution information 400.

The learning module 121 sets the selected data type to the category 401 in each of the added entries. The learning module 121 sets values of from “1” to the maximum value of the position 403 in order from the top entry downward as the position 403. The learning module 121 sets a question mark to the character 402 and sets “NULL” to the appearance count in each of the added entries.

The specific processing of Step S106 is described with reference to FIG. 4. In a case where “Machine ID” is selected in Step S103, the learning module 121 identifies the maximum value of the position 403 as “5”. The learning module 121 accordingly adds five entries to the character appearance distribution information 400. In each of the added entries, the learning module 121 sets “Machine ID” to the category 401, a question mark to the character 402, and “NULL” to the appearance count 404. The learning module 121 further sets values of from “1” to “5” in order from the top entry downward as the position 403. This concludes the description on the processing of Step S106.

The learning server 100 next calculates the range of teacher data belonging to the selected data type (Step S107). The range of teacher data belonging to the selected data type is a value that indicates fluctuations in the data length (character string length) of teacher data belonging to the selected data type.

Specifically, the teacher data length range calculation module 131 of the correction level calculation module 123 calculates, as the range of teacher data belonging to the selected data type, a difference between the maximum character count and minimum character count of teacher data belonging to the selected data type.

The calculation method described above is an example, and this invention is not limited to the method. For instance, dispersion in the data length of teacher data may be used as the range of teacher data belonging to the selected data type.

The learning server 100 next calculates a suggested correction level for the selected data type (Step S108). Specifically, the following processing is executed.

The correction level calculation module 123 calculates the suggested correction level by substituting the range of teacher data belonging to the selected data type in Expression (1).

[Expression (1)]

Lc_suggest=lc_range+1 (1)

In Expression (1), Lc_suggest is a variable that represents a suggested correction level of the selected data type, and lc_range is a variable that represents the range of teacher data belonging to the selected data type.

The correction level calculation module 123 refers to the category 301 of the correction level management information 300 to search for an entry associated with the selected data type. The correction level calculation module 123 sets the calculated correction level to the correction level 302 in the found entry. This concludes the description on the processing of Step S108.

The learning server 100 next displays, when required, the updated suggested correction level in the suggested correction level display field 820 on the correction level setting screen 800 (Step S109).

In a case where the answer to Step S101 is “NO”, or the answer to Step S102 is “YES”, the learning server 100 executes appearance ratio calculation processing (Step S110). The learning server 100 then ends the processing of FIG. 10. The dummy data appearance ratio calculation processing is described with reference to FIG. 11.

FIG. 11 is a flow chart for illustrating an example of the appearance ratio calculation processing executed by the learning server 100 in the first embodiment.

The learning server 100 determines whether input of a correction level has been received (Step S201).

Specifically, the correction level input module 122 determines whether not a value is input or updated by the user in the correction level input field 830 on the correction level setting screen 800.

In a case where it is determined that input of a correction level has not been received, the learning server 100 proceeds to Step S203.

In a case where it is determined that input of a correction level has been received, the learning server 100 updates the correction level management information 300 (Step S202). The learning server 100 then proceeds to Step S203.

Specifically, the correction level input module 122 searches the correction level management information 300 for entries in which the category 301 matches the value in the category input field 810, and sets the value input in the correction level input field 830 to the correction level 302 in the found entries.

In a case where the answer to Step S201 is “NO”, or after the processing of Step S202 is executed, the learning server 100 determines whether appearance ratio calculation is finished for every data type (Step S203).

In a case where it is determined that appearance ratio calculation is finished for every data type, the learning server 100 ends the processing of FIG. 11.

In a case where it is determined that appearance ratio calculation is not finished for every data type, the learning server 100 selects a target data type from among data types for which appearance calculation is not finished (Step S204).

The learning server 100 next refers to the character appearance distribution information 400 to determine whether an entry for dummy data is included in which “NULL” is set to the appearance count 404 (Step S205).

Specifically, the correction level calculation module 123 determines whether the character appearance distribution information 400 includes an entry in which the category 401 is the selected data type, the character 402 is a question mark, and the appearance count 404 is “NULL”.

In a case where it is determined that an entry for dummy data is included in which “NULL” is set to the appearance count 404, the learning server 100 selects a target dummy data entry from among entries for dummy data in which “NULL” is set to the appearance count 404 (Step S206).

The learning server 100 next calculates the range of the appearance counts 404 in entries for characters in which the category 401 is the selected data type and the position 403 is the position 403 of the selected dummy data entry (Step S207). The range of the appearance counts 404 in entries for characters is a value that indicates fluctuations in the value of the position 403.

Specifically, the correction level calculation module 123 searches for entries for characters in which the category 401 and the position 403 match the category 401 and position 403 of the selected dummy data entry. The correction level calculation module 123 identifies the maximum value and minimum value of the found entries for characters to calculate the difference between the maximum value and the minimum value as the range of the appearance counts 404 in the entries for characters. In a case where the difference between the maximum value and the minimum value is “0”, the correction level calculation module 123 changes the range of the appearance counts 404 in the entries for characters to “1”.

The calculation method described above is an example, and this invention is not limited to the method. For instance, dispersion of the appearance counts 404 in the found entries may be used as the range of the appearance counts 404 in the entries for characters.

The learning server 100 next obtains a correction level associated with the selected data type (Step S208).

Specifically, the correction level calculation module 123 refers to the correction level management information 300 to obtain the value of the correction level 302 from an entry in which the category 301 is the same as the data type of the target dummy data.

The learning server 100 next calculates the range of teacher data belonging to the selected data type (Step S209). The processing of Step S209 is the same as the processing of Step S107. However, in a case where a difference between the maximum character count and minimum character count of teacher data belonging to the selected data type is “0”, the learning server 100 sets “1” as the range of teacher data belonging to the selected data type.

The learning server 100 next calculates an appearance count to be set to the selected dummy data entry (Step S210). The learning server 100 then returns to Step S205 to repeat the same processing. In Step S210, the following processing is executed.

The correction level calculation module 123 calculates the appearance count of the target dummy data by Expression (2).

$$[ Expression ( 2 ) ]$$

$${C}_{—} D = {Ccp}_{—} range * \frac{ACc}{{l}_{—} range} \qquad ( 2 )$$

In Expression (2), C_D is a variable that represents an appearance count to be set to the selected dummy data entry, Ccp_range is a variable that represents the range of the appearance counts 404 in entries for characters, which is calculated in Step S207, I_range is a variable that represents the range of teacher data calculated in Step S209, and ACc is a variable that represents the correction level obtained in Step S208. In a case where the correction level is not set, “1” is set to the variable ACc.

The appearance count in Expression (2) is higher when the range of the appearance count 404 is wider, and when the correction level is higher. When the range of teacher data is wider, on the other hand, the appearance count is lower. When the correction level is high, the similarity increases between the target data with dummy data added thereto and teacher data of a data type to which the dummy data belongs.

In a case where ACc and I_range are both “1”, namely, in a case where the correction level and fluctuations in the data length of teacher data are not taken into account, the range of the appearance counts 404 in the entries for characters is calculated as the appearance count of the dummy data.

The correction level calculation module 123 sets the value calculated by Expression (2) to the appearance count 404 in the target dummy data entry. This concludes the description on the processing of Step S210.

In a case where it is determined in Step S205 that there is no dummy data entry in which “NULL” is set to the appearance count 404, the learning server 100 calculates the appearance ratio for every entry that has the selected data type (Step S211). The learning server 100 then returns to Step S203 to repeat the same processing. In Step S211, the following processing is executed.

The learning module 121 refers to the character appearance distribution information 400 to select one entry that has the selected data type. The learning module 121 searches for an entry that holds the same values as the category 401 and the appearance position 403 in the selected entry.

The learning module 121 calculates the appearance ratio for the selected entry by substituting the appearance count 404 of the selected entry and the appearance count 404 of the found entry in Expression (3).

$$[ Expression ( 3 ) ]$$

$$ARcp = \frac{( Appearance count 404 of selected entry )}{( Sum of appearance counts 404 of all found entries )} \qquad ( 3 )$$

The learning module 121 sets the calculated value to the appearance ratio 405 in the selected entry. This concludes the description on the processing of Step S211.

In the learning phase, a given number of entries for dummy data are added to the character appearance distribution information 400 for each data type as described above with reference to FIG. 10 and FIG. 11. A different value is set for each data type as the appearance ratio of dummy data. The appearance ratio of dummy data can be corrected with the use of fluctuations in the data length of teacher data, and the correction level. Through adjustment of the correction level, in particular, the user can suitably change the precision at which the data type of target data is classified. The classification server 101 can take the length of teacher data of each data type into account when the similarity between target data and teacher data is calculated based on the character appearance distribution information 400 as described later.

Details of the processing executed by the classification server 101 are described next with reference to FIG. 12, FIG. 13, FIG. 14, and FIG. 15.

FIG. 12 is a flow chart for outlining the processing executed by the classification server 101 in the first embodiment.

The classification server 101 determines whether a data classification request has been received (Step S301).

For example, the similarity calculation module 151 determines whether a data classification request has been received from the user or other sources. The similarity calculation module 151 may determine that a data classification request has been received in a case where a data string to be classified is received.

In a case where it is determined that a data classification request has not been received, the classification server 101 ends the processing of FIG. 12.

In a case where it is determined that a data classification request has been received, the classification server 101 determines whether to execute similarity calculation processing (Step S302).

Specifically, the similarity calculation module 151 refers to the similarity calculation result information 600 to determine whether there is target data for which the similarity is not calculated or updated. In a case where there is target data for which the similarity is not calculated or updated, the similarity calculation module 151 determines that the similarity calculation processing is to be executed.

In a case where it is determined that the similarity calculation processing is to be executed, the classification server 101 executes the similarity calculation processing (Step S303). Details of the similarity calculation processing are described with reference to FIG. 13. After the similarity calculation processing is finished, the classification server 101 returns to Step S302 to repeat the same processing.

In a case where it is determined that the similarity calculation processing is not to be executed, the classification server 101 executes the classification processing based on the similarity calculation result information 600 (Step S304). Details of the classification processing are described with reference to FIG. 14.

After the classification processing is finished, the classification server 101 outputs the classification result information 700 to the user or the like (Step S305), and then ends the processing of FIG. 12.

When determining that the correction level is required to be changed as a result of referring to the classification result information 700, the user changes the value in the correction level input field 830 on the correction level setting screen 800.

In a case where a new correction level is input, the learning server 100 initializes the appearance count 404 of every entry for dummy data in the character appearance distribution information 400. The learning server 100 then starts the dummy data appearance ratio calculation processing illustrated in FIG. 11. After the dummy data appearance ratio calculation processing is finished, the learning server 100 transmits a data classification request to the classification server 101. The classification server 101 receives the data classification request and executes the processing illustrated in FIG. 12 again. A classification result based on the new correction level is output in this manner.

FIG. 13 is a flow chart for illustrating an example of the similarity calculation processing executed by the classification server 101 in the first embodiment.

The classification server 101 identifies a target data string before starting the processing. For example, the similarity calculation module 151 refers to the classification target data management information 500 to identify a target data string.

The classification server 101 determines whether processing is finished for every target data string (Step S401).

Specifically, the similarity calculation module 151 refers to the similarity calculation result information 600 to determine whether processing is finished for every target data string.

In a case where it is determined that processing is finished for every target data string, the classification server 101 ends the processing of FIG. 13.

In a case where it is determined that processing is not finished for every target data string, the classification server 101 selects one data string (Step S402).

Next, the classification server 101 determines whether processing is finished for every cell included in the selected data string (Step S403).

Specifically, the similarity calculation module 151 refers to the similarity calculation result information 600 to determine whether the similarity is calculated for every cell included in the selected data string.

In a case where it is determined that processing is finished for every cell included in the selected data string, the classification server 101 returns to Step S401 to repeat the same processing.

In a case where it is determined that processing is not finished for every cell included in the selected data string, the classification server 101 selects one cell out of the cells included in the selected data string (Step S404).

The classification server 101 next determines whether similarity calculation is finished with respect to every data type for target data stored in the selected cell (Step S405).

Specifically, the similarity calculation module 151 refers to the similarity calculation result information 600 to determine, for every data type, whether there is an entry associated with the data type. In a case where no associated entry is found for every data type, it is determined that similarity calculation is not finished with respect to every data type for the selected cell.

In a case where it is determined that similarity calculation is finished with respect to every data type for the selected cell, the classification server 101 returns to Step S403 to repeat the same processing.

In a case where it is determined that similarity calculation is not finished with respect to every data type for the selected cell, the classification server 101 selects one data type (Step S406).

The classification server 101 next calculates a difference between the number of characters in teacher data belonging to the selected data type and the number of characters in the target data stored in the selected cell (Step S407).

Specifically, a data length differential calculation module 161 calculates a difference between the minimum character count of teacher data belonging to the selected data type and the character count of the target data stored in the selected cell.

The classification server 101 next refers to the correction level management information 300 to obtain an insertion place and insertion ratio of dummy data (Step S408), and calculates the number of times dummy data is inserted in the insertion place (Step S409). Specifically, the following processing is executed.

A dummy data addition module 162 refers to the correction level management information 300 to search for an entry in which the category 301 matches the selected data type. The dummy data addition module 162 obtains the insertion position 303 and the insertion ratio 304 from the found entry.

The dummy data addition module 162 uses Expression (4) to calculate the insertion count of dummy data to be added at the insertion position 303.

[Expression 4]

DCp=Cc_diff*Rc_D (4)

In Expression (4), DCp is a variable that represents the insertion count of dummy data to be added at the insertion position 303, Cc_diff is a variable that represents the differential value calculated in Step S407, and Rc_D is a variable that represents the insertion ratio 304 of dummy data. This concludes the description on the processing of Step S409.

The classification server 101 next registers, to the similarity calculation result information 600, the target data with dummy data added thereto (Step S410). Specifically, the following processing is executed.

The dummy data addition module 162 refers to the correction level management information 300 to search for an entry in which the category 301 matches the selected data type. The dummy data addition module 162 obtains the insertion position 303 from the found entry.

The dummy data addition module 162 adds as many pieces of dummy data as the insertion count calculated with the use of the insertion position 303 and Expression (4), at a position corresponding to the insertion position 303, to thereby generate post-insertion data. For example, in a case where the insertion position is “TAIL”, the data length of the target data is “3”, and the value of Expression (4) is “5”, the dummy data addition module 162 adds two pieces of dummy data at the tail end of the target data.

The dummy data addition module 162 adds an entry to the similarity calculation result information 600, and sets the name of the selected cell and identification information of the selected data string to the cell name 601 and the data ID 602, respectively, in the added entry. The dummy data addition module 162 also sets the post-insertion data to the post-insertion data 603, and sets the selected data type to the target category 604. This concludes the description on the processing of Step S410.

The classification server 101 next calculates similarity for the post-insertion data (Step S411).

Specifically, the similarity calculation module 151 reads one character out of the post-insertion data 603. The similarity calculation module 151 refers to the character appearance distribution information 400 to search for an entry in which the category 401, the character 402, and the position 403 match the selected data type, the read character, and the position of the read character, respectively. The similarity calculation module 151 obtains the appearance ratio 405 from the found entry.

The similarity calculation module 151 executes the same processing for every character in the post-insertion data 603, to thereby obtain the appearance ratio 405 for each character. The similarity calculation module 151 calculates the similarity by the multiplication of the appearance ratios 405 of the respective characters. The similarity calculation module 151 sets the calculated similarity to the similarity 605. This concludes the description on the processing of Step S411.

The similarity of post-insertion data to which dummy data is already added can be calculated because the appearance ratio is set for dummy data as well.

FIG. 14 is a flow chart for illustrating an example of the classification processing executed by the classification server 101 in the first embodiment.

The classification server 101 calculates a classification threshold (Step S501). Specifically, the following processing is executed.

The classification threshold calculation module 153 calculates, for each data type, a difference between the maximum character count of teacher data and the minimum character count of teacher data. The classification threshold calculation module 153 compares the character count difference of one data type and the character count difference of another data type to identify the maximum value of the character count difference and the minimum value of the character count difference.

The classification threshold calculation module 153 calculates, as a classification threshold, a difference between the maximum value of the character count difference and the minimum value of the character count difference, and outputs the classification threshold to the data classification module 152. This concludes the description on the processing of Step S501.

The classification server 101 next determines whether classification is finished for every piece of target data (Step S502).

Specifically, the data classification module 152 refers to the similarity calculation result information 600 and the classification result information 700 to determine whether there is target data for which a classification result is not registered in the classification result information 700. In a case where there is target data for which a classification result is not registered in the classification result information 700, the data classification module 152 determines that classification is not finished for every piece of target data.

In a case where it is determined that classification is finished for every piece of target data, the classification server 101 ends the processing of FIG. 14.

In a case where it is determined that classification is not finished for every piece of target data, the classification server 101 selects one piece of target data (Step S503).

Specifically, the data classification module 152 refers to the similarity calculation result information 600 to select one piece of target data from among pieces of unclassified target data.

The classification server 101 next obtains the maximum value and minimum value of the similarity of the target data from the similarity calculation result information 600 (Step S504).

Specifically, the data classification module 152 refers to the similarity 605 in entries for the selected target data in the similarity calculation result information 600 to obtain the maximum value and minimum value of the similarity of the target data.

The classification server 101 next uses the similarity and the classification threshold to determine whether classification based on the similarity is possible (Step S505). In other words, whether meaningful target data can be classified is determined.

Specifically, the data classification module 152 determines whether Expression (5) is satisfied. The data classification module 152 determines that classification based on the similarity is possible in a case where Expression (5) is satisfied.

[Expression 5]

S_l<S_ĥ(Threshold+1) (5)

In Expression (5), S_h is a variable that represents the maximum value of the similarity of the target data, S_l is a variable that represents the minimum value of the similarity of the target data, and Threshold is a variable that represents the classification threshold.

In a case where it is determined that classification based on the similarity is possible, the classification server 101 registers a data type having the highest similarity to the classification result information 700 (Step S506). The classification server 101 then returns to Step S502 to repeat the same processing. Specifically, the following processing is executed.

The data classification module 152 sets the target category 604 of an entry in which the similarity 605 has the maximum value to the data type of the target data. The data classification module 152 obtains the target category 604 from this entry. The data classification module 152 adds an entry to the classification result information 700 and, in the added entry, sets the data ID 602 and cell name 601 of the entry in which the similarity 605 has the maximum value to the data ID 701 and the cell name 702.

The data classification module 152 also sets the value of the target data to the data 703 in the added entry, and sets the value of the target category 604 to the classification result 704 in the added entry. This concludes the description on the processing of Step S506.

In a case where it is determined that classification based on the similarity is not possible, the classification server 101 registers “n/a” to the classification result information 700 (Step S507). The classification server 101 then returns to Step S502 to repeat the same processing.

The processing of Step S507 is the same as the processing of Step S506, except that “n/a” is registered to the classification result information 700.

The classification server 101 executes the processing described above for every combination of a data string and a cell name. The classification result information 700 as the one shown in FIG. 7 is generated in this manner.

Mathematical expressions from Expression (1) to Expression (5) are given as an example, and the first embodiment is not limited thereto. Mathematical expressions used are only required to be related to the lengths of pieces of teacher data of the respective data types.

As described above, the learning server 100 generates the character appearance distribution information 400 in which the appearance ratio of dummy data inserted into target data to suit the data type is set. The classification server 101 adjusts the data length of target data to suit the data type, and uses the character appearance distribution information 400 to calculate the similarity between the target data to which dummy data is already added and teacher data. The data type of IDs and other character strings difficult to classify with the related art can thus be classified.

In the case of an analysis using a data string that includes a cell of indefinite attributes, in particular, the data type of target data stored in the cell can be classified efficiently by applying this invention thereto. The time required to, for example, understand data can accordingly be shortened significantly.

### Modification Example

The classification method in the first embodiment and the classification method of the related art can be combined to classify data of every cell in a data string. An example of a possible method is given below.

The data classification module 152 selects a data string, and determines whether every piece of target data in the selected data string is successfully classified. Specifically, the data classification module 152 refers to the classification result 704 of the classification result information 700 to determine whether there is character string data that has “n/a” as the classification result 704.

In a case where there is character string data that has “n/a” as the classification result 704, the data classification module 152 determines that not every piece of character string data in the selected data string is successfully classified.

In a case where it is determined that not every piece of character string data in the selected data string is successfully classified, the data classification module 152 extracts the character string data that has “n/a” as the classification result 704, and applies the classification method of the related art to the extracted character string data.

The present invention is not limited to the above embodiment and includes various modification examples. In addition, for example, the configurations of the above embodiment are described in detail so as to describe the present invention comprehensibly. The present invention is not necessarily limited to the embodiment that is provided with all of the configurations described. In addition, a part of each configuration of the embodiment may be removed, substituted, or added to other configurations.

A part or the entirety of each of the above configurations, functions, processing units, processing means, and the like may be realized by hardware, such as by designing integrated circuits therefor. In addition, the present invention can be realized by program codes of software that realizes the functions of the embodiment. In this case, a storage medium on which the program codes are recorded is provided to a computer, and a CPU that the computer is provided with reads the program codes stored on the storage medium. In this case, the program codes read from the storage medium realize the functions of the above embodiment, and the program codes and the storage medium storing the program codes constitute the present invention. Examples of such a storage medium used for supplying program codes include a flexible disk, a CD-ROM, a DVD-ROM, a hard disk, a solid state drive (SSD), an optical disc, a magneto-optical disc, a CD-R, a magnetic tape, a non-volatile memory card, and a ROM.

The program codes that realize the functions written in the present embodiment can be implemented by a wide range of programming and scripting languages such as assembler, C/C++, Perl, shell scripts, PHP, and Java (registered trademark).

It may also be possible that the program codes of the software that realizes the functions of the embodiment are stored on storing means such as a hard disk or a memory of the computer or on a storage medium such as a CD-RW or a CD-R by distributing the program codes through a network and that the CPU that the computer is provided with reads and executes the program codes stored on the storing means or on the storage medium.

In the above embodiment, only control lines and information lines that are considered as necessary for description are illustrated, and all the control lines and information lines of a product are not necessarily illustrated. All of the configurations of the embodiment may be connected to each other.

What is claimed is:

1. A computer system, comprising a plurality of computers,
each of the plurality of computers having a processor, a main storage device coupled to the processor, and an interface coupled to the processor,
at least one of the plurality of computers including a learning module,
the learning module being configured to use a plurality of pieces of teacher data belonging to a plurality of data types, respectively, to generate distribution information for calculating an index that is used in classification of a data type of target data, and output the distribution information to a computer that includes a classification module, which is configured to use the distribution information to classify the data type of the target data,
each of the plurality of pieces of teacher data comprising a character string, which includes at least one character,
wherein the learning module is configured to:
execute learning processing, which uses the plurality of pieces of teacher data belonging to the plurality of data types, respectively, to thereby add, to the distribution information, a plurality of first entries each including one of the plurality of data types, a character included in one of the plurality of pieces of teacher data belonging to the one of the plurality of data types, and an appearance position at which the character appears in a character string;
add, to the distribution information, a given number of second entries each including one of the plurality of data types, dummy data added in order to adjust a data length of the target data, and an appearance position at which the dummy data appears in a character string;
calculate first probabilities based on data lengths of the plurality of pieces of teacher data belonging to the plurality of data types that are included in the plurality of first entries, the first probabilities each indicating a probability at which the character included in one of the plurality of first entries appears at an appearance position included in the one of the plurality of first entries;
calculate second probabilities based on data lengths of the plurality of pieces of teacher data belonging to the plurality of data types that are included in the given number of second entries, the second probabilities each indicating a probability at which the dummy data included in one of the given number of second entries appears at an appearance position included in the one of the given number of second entries; and
set the first probabilities and the second probabilities to the plurality of first entries and the given number of second entries, respectively.

2. The computer system according to claim 1, wherein the learning module is configured to:
calculate, for each of the plurality of data types, a first range, which indicates fluctuations in data length of the plurality of pieces of teacher data belonging to the same data type;
calculate, for each of the plurality of data types, a correction level for correcting a value related to the dummy data based on the first range of the each of the plurality of data types;
calculate a first appearance count, which indicates how many times the character included in one of the plurality of first entries appears at the appearance position included in the one of the plurality of first entries;
calculate a second appearance count, which indicates how many times the dummy data included in one of the given number of second entries appears at the appearance position included in the one of the given number of second entries;
calculate the first probabilities based on the correction levels of the plurality of data types included in the plurality of first entries, the first ranges of the plurality of data types included in the plurality of first entries, and the first appearance counts; and
calculate the second probabilities based on the correction levels of the plurality of data types included in the given number of second entries, the first ranges of the plurality of data types included in the given number of second entries, and the second appearance counts.

3. The computer system according to claim 2,
wherein the at least one of the plurality of computers includes the classification module,
wherein the index is similarity between target data to which the dummy data is already added and the plurality of pieces of teacher data belonging to an arbitrary data type, and
wherein the classification module is configured to:
select one of the plurality of data types;
calculate an insertion count of the dummy data based on a first differential, which is a difference between a minimum data length of the plurality of pieces of teacher data belonging to the selected one of the plurality of data types and the data length of the target data;
add as many pieces of dummy data as the insertion count at a given position in the target data;
refer to the distribution information to obtain one of the first probabilities and one of the second probabilities, based on the character included in the target data to which the dummy data is already added and a position of the character; and
use the one of the first probabilities and the one of the second probabilities to calculate the similarity.

4. The computer system according to claim 3, wherein the classification module is configured to:
calculate, for each of the plurality of data types, a differential between the data length of the plurality of pieces of teacher data belonging to the each of the plurality of data types and the data length of the target data, and use the differential to calculate a threshold;
compare the similarity of one of the plurality of data types and the similarity of another of the plurality of data types, to thereby identify a maximum value of the similarity and a minimum value of the similarity;
use the threshold, the maximum value of the similarity, and the minimum value of the similarity to determine whether it is possible to classify the data type of the target data based on the similarity; and
set the data type that has the highest similarity as the data type of the target data in a case where it is determined that it is possible to classify the data type of the target data based on the similarity.

5. A data classification method for use in a computer system comprising a plurality of computers,
each of the plurality of computers having a processor, a main storage device coupled to the processor, and an interface coupled to the processor,
at least one of the plurality of computers including a learning module,
the learning module being configured to use a plurality of pieces of teacher data belonging to a plurality of data types, respectively, to generate distribution information for calculating an index that is used in classification of a data type of target data, and output the distribution information to a computer that includes a classification module, which is configured to use the distribution information to classify the data type of the target data,
each of the plurality of pieces of teacher data including a character string, which comprises at least one character,
the data classification method including:
a first step of executing, by the learning module, learning processing, which uses the plurality of pieces of teacher data belonging to the plurality of data types, respectively, to thereby add, to the distribution information, a plurality of first entries each including one of the plurality of data types, a character included in one of the plurality of pieces of teacher data belonging to the one of the plurality of data types, and an appearance position at which the character appears in a character string;
a second step of adding, by the learning module, to the distribution information, a given number of second entries each including one of the plurality of data types, dummy data added in order to adjust a data length of the target data, and an appearance position at which the dummy data appears in a character string;
a third step of calculating, by the learning module, first probabilities based on data lengths of the plurality of pieces of teacher data belonging to the plurality of data types that are included in the plurality of first entries, the first probabilities each indicating a probability at which the character included in one of the first entries appears at an appearance position included in the one of the plurality of first entries;
a fourth step of calculating, by the learning module, second probabilities based on data lengths of the plurality of pieces of teacher data belonging to the plurality of data types that are included in the given number of second entries, the second probabilities each indicating a probability at which the dummy data included in one of the given number of second entries appears at an appearance position included in the one of the given number of second entries; and
a fifth step of setting, by the learning module, the first probabilities and the second probabilities to the plurality of first entries and the given number of second entries, respectively.

6. The data classification method according to claim 5, further including:
calculating, by the learning module, a first range for each of the plurality of data types after the second step is executed, the first range indicating fluctuations in data length of the plurality of pieces of teacher data belonging to the same data type; and
calculating, by the learning module, a correction level for correcting a value related to the dummy data, for each of the plurality of data types, based on the first range of the each of the plurality of data types,
wherein the first step includes calculating, by the learning module, a first appearance count, which indicates how many times the character included in one of the plurality of first entries appears at the appearance position included in the one of the plurality of first entries,
wherein the second step includes calculating, by the learning module, a second appearance count, which indicates how many times the dummy data included in one of the given number of second entries appears at the appearance position included in the one of the given number of second entries,
wherein the third step includes calculating, by the learning module, the first probabilities based on the correction levels of the plurality of data types included in the plurality of first entries, the first ranges of the plurality of data types included in plurality of first entries, and the first appearance counts, and
wherein the fourth step includes calculating, by the learning module, the second probabilities based on the correction levels of the plurality of data types included in the given number of second entries, the first ranges of the plurality of data types included in the given number of second entries, and the second appearance counts.

7. The data classification method according to claim 6,
wherein the at least one of the plurality of computers includes the classification module,
wherein the index is similarity between target data to which the dummy data is already added and the plurality of pieces of teacher data belonging to an arbitrary data type, and
wherein the data classification method further includes:
selecting, by the classification module, one of the plurality of data types;
calculating, by the classification module, an insertion count of the dummy data based on a first differential, which is a difference between a minimum data length of the plurality of pieces of teacher data belonging to the selected one of the plurality of data types and the data length of the target data;
adding, by the classification module, as many pieces of dummy data as the insertion count at a given position in the target data;
referring, by the classification module, to the distribution information to obtain one of the first probabilities and one of the second probabilities, based on the character included in the target data to which the dummy data is already added and a position of the character; and
using, by the classification module, the one of the first probabilities and the one of the second probabilities to calculate the similarity.

8. The data classification method according to claim 7, further including:
calculating, by the classification module, for each of the plurality of data types, a differential between the data length of the plurality of pieces of teacher data belonging to the each of the plurality of data types and the data length of the target data, and using the differential to calculate a threshold;
comparing, by the classification module, the similarity of one of the plurality of data types and the similarity of another of the plurality of data types, to thereby identify a maximum value of the similarity and a minimum value of the similarity;
using, by the classification module, the threshold, the maximum value of the similarity, and the minimum value of the similarity to determine whether it is possible to classify the data type of the target data based on the similarity; and
setting, by the classification module, the data type that has the highest similarity as the data type of the target data in a case where it is determined that it is possible to classify the data type of the target data based on the similarity.

9. A computer system, comprising a plurality of computers,
each of the plurality of computers having a processor, a main storage device coupled to the processor, and an interface coupled to the processor,
at least one of the plurality of computers including a classification module, which is configured to use distribution information for calculating an index to classify a data type of target data, the index being used in classification of the data type of target data,
each of the plurality of pieces of teacher data comprising a character string, which comprises at least one character,
the distribution information including:
a plurality of first entries each including one of the plurality of data types, a character included in one of the plurality of pieces of teacher data belonging to the one of the plurality of data types, an appearance position at which the character appears in a character string, and a first probability indicating a probability at which the character appears at the appearance position; and
a given number of second entries each including one of the plurality of data types, dummy data added in order to adjust a data length of the target data, an appearance position at which the dummy data appears in a character string, and a second probability indicating a probability at which the dummy data appears at the appearance position,
wherein the classification module is configured to:
select one of the plurality of data types;
calculate an insertion count of the dummy data based on a first differential, which is a difference between a minimum data length of the plurality of pieces of teacher data belonging to the selected one of the plurality of data types and the data length of the target data;
add as many pieces of dummy data as the insertion count at a given position in the target data;
refer to the distribution information to obtain the first probability and the second probability, based on the character included in the target data to which the dummy data is already added and a position of the character; and
use the first probability and the second probability to calculate the index.

10. The computer system according to claim 9,
wherein the index is similarity between target data to which the dummy data is already added and the plurality of pieces of teacher data belonging to an arbitrary data type, and
wherein the classification module is configured to:
calculate, for each of the plurality of data types, a differential between the data length of the plurality of pieces of teacher data belonging to the each of the plurality of data types and the data length of the target data, and use the differential to calculate a threshold;
compare the similarity of one of the plurality of data types and the similarity of another of the plurality of data types, to thereby identify a maximum value of the similarity and a minimum value of the similarity;
use the threshold, the maximum value of the similarity, and the minimum value of the similarity to determine whether it is possible to classify the data type of the target data based on the similarity; and
set the data type that has the highest similarity as the data type of the target data in a case where it is determined that it is possible to classify the data type of the target data based on the similarity.

11. The computer system according to claim 9,
wherein the at least one of the plurality of computers includes a learning module, which is configured to generate the distribution information, and
wherein the learning module is configured to:
execute learning processing, which uses the plurality of pieces of teacher data belonging to the plurality of data types, respectively, to thereby add, to the distribution information, the plurality of first entries each including one of the plurality of data types, the character included in one of the plurality of pieces of teacher data belonging to the one of the plurality of data types, and an appearance position at which the character appears in a character string;
add, to the distribution information, the given number of second entries each including one of the plurality of data types, the dummy data, and an appearance position at which the dummy data appears in a character string;
calculate the first probabilities based on data lengths of the plurality of pieces of teacher data belonging to the plurality of data types that are included in the plurality of first entries;
calculate the second probabilities based on data lengths of the plurality of pieces of teacher data belonging to the plurality of data types that are included in the given number of second entries; and
set the first probabilities and the second probabilities to the plurality of first entries and the given number of second entries, respectively.

12. The computer system according to claim 11, wherein the learning module is configured to:
calculate, for each of the plurality of data types, a first range, which indicates fluctuations in data length of the plurality of pieces of teacher data belonging to the same data type;
calculate, for each of the plurality of data types, a correction level for correcting a value related to the dummy data based on the first range of the each of the plurality of data types;
calculate a first appearance count, which indicates how many times the character included in one of the plurality of first entries appears at the appearance position included in the one of the plurality of first entries;
calculate a second appearance count, which indicates how many times the dummy data included in one of the given number of second entries appears at the appearance position included in the one of the given number of second entries;
calculate the first probabilities based on the correction levels of the plurality of data types included in the plurality of first entries, the first ranges of the plurality of data types included in the plurality of first entries, and the first appearance counts; and
calculate the second probabilities based on the correction levels of the plurality of data types included in the given number of second entries, the first ranges of the plurality of data types included in the given number of second entries, and the second appearance counts.
